(19) United States
(12) Patent Application Publication
(10) Pub. No.: US 2018/0325126 A1
(43) Pub. Date: Nov. 15, 2018

(54) PRODUCT PACKAGING AND METHOD OF USING THE SAME

(71) Applicants: Alex J. Phinn, Fallsington, PA (US); Brack Mulliner, San Marcos, CA (US)

(72) Inventors: Alex J. Phinn, Fallsington, PA (US); Brack Mulliner, San Marcos, CA (US)

(21) Appl. No.: 16/032,680

(22) Filed: Jul. 11, 2018

Related U.S. Application Data
(60) Provisional application No. 62/504,575, filed on May 11, 2017.

(51) Int. Cl. A21D 10/02; B65D 85/36; B65D 5/50

(52) U.S. Cl. CPC A21D 10/025; B65D 5/5038; B65D 85/36

(57) ABSTRACT

A packaging system for uncooked edible goods including a sheet of a baking substrate and a box for transporting the sheet and goods. The sheet has a first length and first width and the box has one or both of a second length and second width, where the second length is smaller than the first length and the second width is smaller than the first width. One or more folds in the sheet enable the sheet to be folded in order to fit into the smaller-dimensioned box. Uncooked edible goods are placed on a goods-receiving surface of the folded sheet. The box is delivered to a retailer. The folded sheet is removed from the box, is placed onto a baking pan, and is unfolded while the edible goods remain thereon. The goods are moved apart from each other, the pan is placed into an oven, and the goods are cooked.

### CROSS REFERENCE TO RELATED APPLICATIONS

This application claims the benefit of U.S. Provisional Patent Application Ser. No. 62/504,575 filed May 11, 2017, the entire disclosure of which is incorporated herein by reference.

### BACKGROUND

### Technical Field

This disclosure is directed generally to food production. More particularly, this disclosure is related to the production and shipping of uncooked food products from a production facility to a retailer. Specifically, this disclosure is directed to a packaging system and a method of use thereof, where the packaging system includes an industry standard sized sheet of a baking substrate that is folded in order to fit into a smaller-dimensioned box that is then used to transport uncooked edible goods to the retailer. When the goods are to be cooked or baked, the sheet is removed from the box, is placed on a baking pan, and is unfolded to return it to the industry standard size while the goods remain thereon. The sheet is used as a baking pan liner during cooking or baking of the edible goods.

### Background Information

Currently, many types of cookies and other edible goods are prepared and packaged at production facilities and are then shipped to retailers for sale. In many instances, these products are shipped in an uncooked state and the retailer will cook the products prior to sale.

In the production facility, the cookies are prepared and placed onto sheets of grease-proof or parchment paper. The sheets of parchment paper with cookies thereon are then placed into shipping boxes that are subsequently shipped to the retailer. It is standard in the industry to use parchment sheets that are 24×sixteen inches in size. The shipping boxes in which the uncooked products are placed are therefore sized to be equal to or larger than the 24×sixteen inch sheets of parchment paper. In order to reduce the tendency of the goods to be damaged during shipping, it is typical to place the cookies at spaced intervals from each other on the parchments sheets. The result of this is that there is a lot of wasted space in the shipping boxes. The costs of shipping these larger size boxes is also quite high relative to the number of cookies they are capable of carrying. There is also a tendency for cookies to shift on the sheets while being shipped and as a result many cookies arrive damaged at the retailer.

### SUMMARY

There is therefore a need in the art for an improved method of packaging and shipping uncooked goods to retailers.

A packaging system for uncooked edible goods is disclosed herein. The packaging system includes a sheet of a baking substrate or a cooking substrate that is suitable for receiving edible goods thereon and a box for transporting the sheet and a plurality of uncooked edible goods from a manufacturer to a retailer. The baking substrate or cooking substrate may comprise any type of paper, film, or liner onto which an edible good may be placed during production of the edible good. The baking substrate or cooking substrate may further be comprised of any material that is suitable to be used as a liner during a baking process or cooking process. Still further, the baking substrate or cooking substrate may be a material that is food-grade, i.e., does not impart any substances to the edible good that may not safe for human consumption. Suitable materials for the baking substrate or cooking substrate include but are not limited to parchment paper, grease-proof paper, baking paper, and paper pan liners. All suitable materials that may be used for this purpose will be referred to herein as a “baking substrate”.

As indicated above, the system further includes a box for transporting the sheet and the uncooked edible goods from a manufacturer of the edible goods to a retailer. The sheet of baking substrate has a first length and first width and the box has one or both of a second length and second width, where the second length is smaller than the first length and the second width is smaller than the first width. One or more folds or one or more fold lines in the sheet enable the sheet to be folded in order to fit into the smaller-dimensioned box. (It will be understood that the terms “fold” and “fold line” may be used interchangeably herein.) Uncooked edible goods are placed on a goods-receiving surface of the sheet. The box is delivered to a retailer. The sheet is removed from the box, is placed onto a baking pan, and is unfolded while the edible goods remain thereon. The goods are moved apart from each other, the pan is placed into an oven, and the goods are cooked.

In one aspect, the present disclosure may provide a method of packaging, shipping and cooking an uncooked edible good comprising providing a sheet that is of a first length and of a first width; folding a first region of the sheet relative to a second region of the sheet about a first fold; reducing one or both of the first length to a second length and the first width to a second width through the folding to produce a reduced dimension sheet; placing one or more edible goods on the reduced dimension sheet; placing the reduced dimension sheet with the one or more edible goods thereon into an interior cavity of a box; and transporting the box from a first location to a second location. The method may further include selecting the box for transporting the one or more edible goods, where the box has one or both of the second length and the second width. The step of reducing does not include one or both of cutting the sheet to reduce the first length to the second length and cutting the sheet to reduce the first width to the second width.

The method may further include removing the reduced dimension sheet with the one or more edible goods thereon from the box at the second location; unfolding the reduced dimension sheet to form an unfolded sheet; and increasing one or both of the second length to the first length and the second width to the first width by the unfolding. The method may further include placing the unfolded sheet onto a baking pan; placing the baking pan into an oven; and cooking the one or more edible goods with the oven. In another example, the method may include removing the one or more edible goods from the reduced dimension sheet at the second location; placing the one or more edible goods onto a baking pan; placing the baking pan into an oven; and cooking the one or more edible goods with the oven.

The folding may further comprise forming the first fold line in the sheet such that the first fold line extends from a first edge to a second edge of the sheet; and spacing the first fold line a first distance from a first side of the sheet. The folding may further comprise forming a second fold line in the sheet; where the second fold line extends from the first edge to the second edge of the sheet; wherein the second fold line is spaced laterally from the first fold line and is parallel thereto; and spacing the second fold line a second distance from a second side of the sheet. The folding may further comprise forming an additional fold line in the sheet, wherein the additional fold line is oriented at right angles to the first fold line. The folding may further comprise forming a third fold line and a fourth fold line in the sheet, wherein the third fold line and the fourth fold line are oriented at right angles to the first fold line and the second fold line; and wherein the fourth fold line is spaced longitudinally from the third fold line. In another example, the folding may further comprise defining a first region of the sheet between a first side and the first fold line; defining a second region of the sheet between the first fold line and the second fold line; defining a third region of the sheet between the second fold line and a second side; and folding the first region relative to the second region about the first fold line in a first direction; and folding the second region relative to the third about the second fold line in a second direction; wherein the reduced dimension sheet has a Z-shape when viewed from an end that is oriented at right angles to the first side. The method may further comprise spacing the first fold line a first distance from the first side; spacing the second fold line a second distance from the second side; and spacing the first fold line a third distance from the second fold line. The spacing of the first fold line and the second fold line may include selecting the first distance, the second distance and the third distance to be of equal size. The method may further comprise unfolding the Z-shape of the sheet by holding the first side of the sheet stationary and moving the second side of the sheet laterally away from the first side in a direction perpendicular to the first side.

In another aspect, the present disclosure may provide a packaging system for one or more edible goods comprising a sheet of a baking substrate The sheet is of a first length and a first width; a goods-receiving surface provided on the sheet; wherein the goods-receiving surface is adapted to receive one or more edible goods thereon; a box having an interior cavity for receiving the sheet therein; wherein the box has one or both of a second length and a second width, wherein the second length is smaller than the first length and the second width is smaller than the first width; and wherein the sheet of paper is folded in order to be received into the interior cavity of the box. The sheet may include a first fold line about which a first region of the sheet is folded relative to a second region of the sheet to change one or both of the first length to the second length and the first width to the second width. The sheet may further include a second fold line about which a third region of the sheet is folded relative to the second region of the sheet to change one or both of the first length to the second length and the first width to the second width. In a first example, the first fold line and the second fold line may be parallel to each other. In a second example, the first fold line and the second fold line may be oriented at right angles to each other.

In one example, the sheet is folded in a first direction around the first fold line and is folded in a second direction around the second fold line; wherein the sheet has a Z-shape when viewed from an end of the sheet that is oriented at right angles to the first fold line.

In another example, the sheet may further include a third fold line oriented at right angles to the first fold line; and wherein a fourth region of the sheet is folded about the third fold line relative to the second region of the sheet to change one or both of the first length to the second length and the first width to the second width. In yet another example the sheet may further include a fourth fold line spaced longitudinally from the third fold line and oriented parallel to the third fold line; and wherein a fifth region of the sheet is folded about the fourth fold line relative to the second region of the sheet to change one or both of the first length to the second length and the first width to the second width.

In another aspect, the present disclosure may provide a packaging system for one or more edible goods comprising a sheet of a baking substrate that is of a first length and a first width; at least one fold line provided on the sheet; wherein a first region of the sheet is foldable relative to a second region of the sheet about the at least one fold line to reduce one or both of the first length to a second length and the first width to a second width; a goods-receiving surface provided on the sheet; and one or more edible goods positioned on the goods-receiving surface. The system may further comprise one or more markings provided on the goods-receiving surface, wherein each of the one or more markings indicates where to position each of the one or more edible goods. The system may further comprise one or more detents of food-grade adhesive provided on the goods-receiving surface, wherein each of the one or more detents of food-grade adhesive secures one of the one or more edible goods to the goods-receiving surface.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a diagrammatic overview of a PRIOR ART method of packaging, shipping, and cooking edible goods.

FIG. 1A is a diagrammatic view of a first section of the PRIOR ART method.

FIG. 1B is a diagrammatic view of a second section of the PRIOR ART method.

FIG. 1C is a diagrammatic view of a third section of the PRIOR ART method.

FIG. 2 is a diagrammatic overview of a first method of packaging, shipping, and cooking edible goods in accordance with an aspect of the present disclosure.

FIG. 2A is a diagrammatic view of a first section of the first method in accordance with the present disclosure.

FIG. 2B is a diagrammatic view of a second section of the first method.

FIG. 2C is a diagrammatic view of a third section of the first method.

FIG. 3A is a top plan view of a single sheet of a baking substrate that has been cut from a roll and is ready to be moved through the first method illustrated in FIG. 2; and showing markings that indicate where edible goods should be placed prior to baking or cooking of the edible goods.

FIG. 3B is a top plan view of a single sheet of a baking substrate that has been cut from a roll and is ready to be moved through the first method illustrated in FIG. 2; and showing food-grade adhesive detents applied to a goods-receiving surface of the sheet for securing edible goods thereto.

FIG. 4 is a diagrammatic overview of a second method of packaging, shipping and cooking edible goods in accordance with an aspect of the present disclosure.

FIG. 4A is a diagrammatic view of a first section of the second method in accordance with the present disclosure.

FIG. 4B is a diagrammatic view of a second section of the second method.

FIG. 4C is a diagrammatic view of a third section of the second method.

FIG. 5 is a top plan view of a single sheet of a baking substrate that has been cut from a roll and showing two parallel fold lines.

FIG. 6 is an end elevation view of the sheet of FIG. 5 that has been folded about the two parallel fold lines to assume a Z-shape.

FIG. 7 is a top perspective view of the sheet of FIG. 6 with a plurality of edible goods on a goods-receiving surface of the sheet.

FIG. 8 is an end elevation view of the sheet of FIG. 5 folded about the two parallel lines in a different manner.

Similar numbers refer to similar parts throughout the drawings.

### DETAILED DESCRIPTION

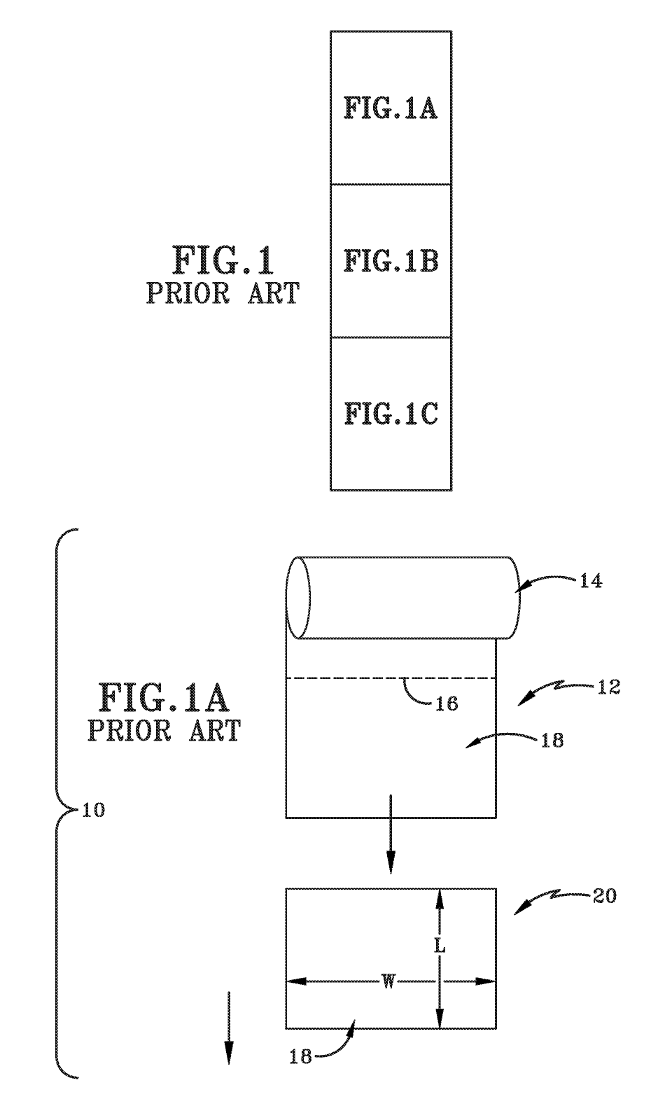

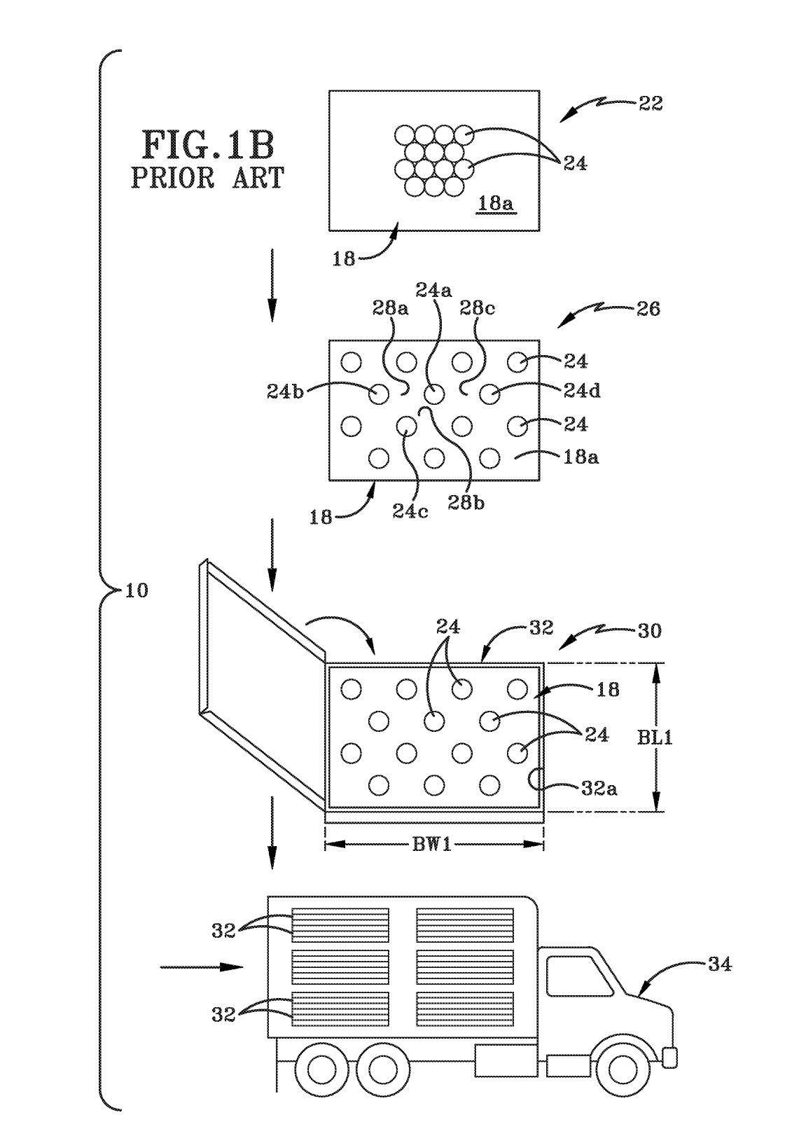

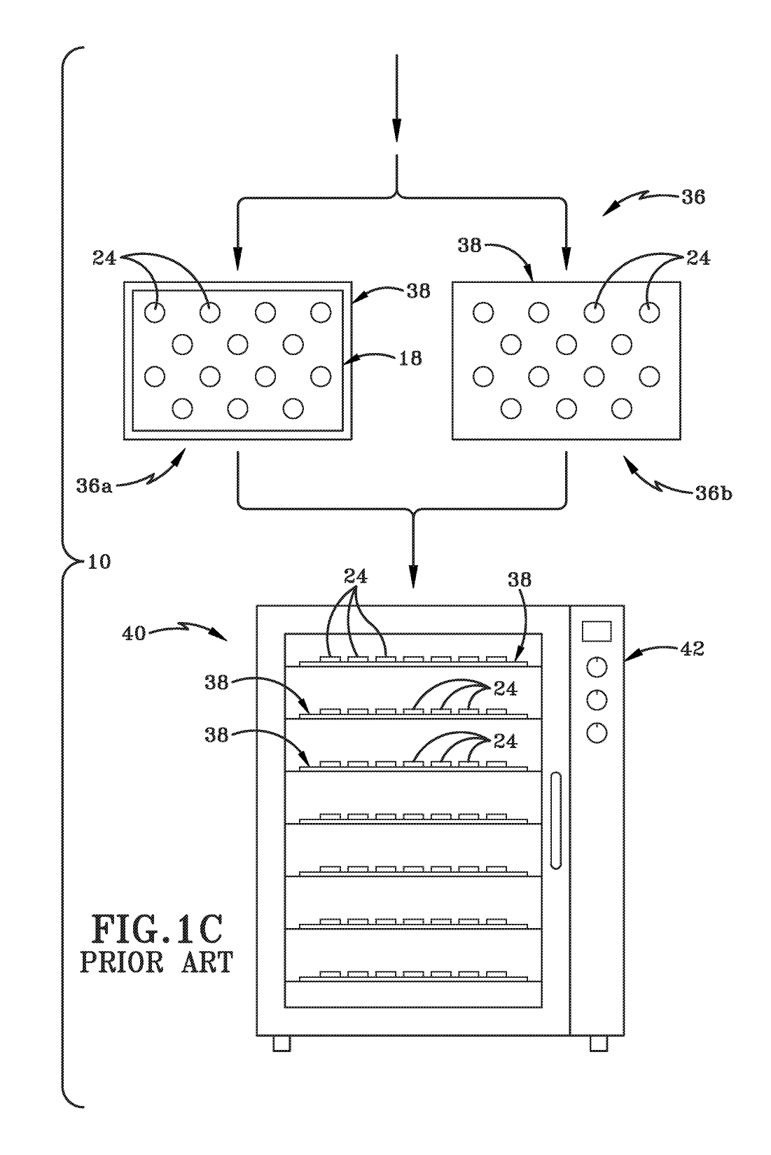

Referring to FIGS. 1 to 1C, there is shown a PRIOR ART method of packaging goods. The method is generally referenced by the number 10. In a first step 12 of the method, a twenty-four inch wide roll 14 of a baking substrate is provided. Roll 14 is passed through a cutting process where a cutting implement (not shown) is used to cut sixteen inch long sheets of baking substrate from roll 14. A line of weakness 16 is illustrated on the length of baking substrate extending outwardly from roll 14 to demonstrate where the cutting implement may cut a single sheet 18 from roll 14 in a second step 20 of the method. A single sheet 18 of baking substrate is shown as having a length “L” that is sixteen inches long and a width “W” that is twenty-four inches wide. This size of sheet 18 is standard in the industry that is involved in the preparation, packaging, and delivery of uncooked edible goods to businesses that subsequently bake or cook those edible goods. It will be understood that a plurality of single sheets 18 will be cut from roll 14.

In a third step 22 of the PRIOR ART method, a plurality of uncooked edible goods 24 (hereafter “goods 24”) are placed on an upper surface 18a of sheet 18. Initially goods 24 may be randomly placed on upper surface 18a of sheet 18. Goods 24 may include but are not limited to goods to be baked such as balls or rounds of cookie dough. The balls or rounds of goods 24 may all be of a generally identical shape, size, and weight, and be comprised of the same ingredients.

Goods 24 may be placed onto upper surface 18a of sheet 18 in any one of a plurality of different ways including passing sheet 18 under a plurality of nozzles that deposit a quantity of cookie dough thereon. Alternatively, sheet 18 may be moved under or proximate a plurality of gates that open and the individual goods 24 may be dropped or moved onto the upper surface 18a of sheet 18. Any manner of depositing goods 24 onto sheet 18 may be utilized.

In a fourth step 26 of the PRIOR ART method, during or after the placement of goods 24 onto sheet 18, the goods 24 may be arranged into a pattern on upper surface 18a of sheet 18. For example, the goods 24 may be arranged in a plurality of rows and/or a plurality of columns such that there is a space that separates each single good 24 from each adjacent single good 24. For example, as shown in FIGS. 1 to 1C, good 24a is separated from good 24b by a space identified by the number 28a. Furthermore, good 24a may also be separated from good 24c by a space 28b and from good 24d by a space 28c. The various spaces 28a, 28b, 28c may of the same size in one example but in other examples may be of different sizes.

In a fifth step 30, sheet 18 with the spaced-apart goods 24 thereon is placed into an interior cavity 32a of a shipping box 32. Box 32 has a length “BL1” that is marginally larger than the length “L” of sheet 18. Box 32 has a width “BW1 that is marginally larger than the width “W” of sheet 18. In a sixth step, a plurality of boxes 32 are placed onto a transportation vehicle 34 and are shipped to a customer.

Sometime later at the customer's facility, a decision is made to cook or bake goods 24. In a seventh step 36 one of two scenarios may occur. In a first scenario 36a, sheet 18 with goods 24 thereon is placed onto a baking pan 38. In a second scenario 36b, goods 24 are removed from sheet 18 and goods 24 are placed directly onto a baking pan 38. In the first scenario, the sheet 18 is thrown away once goods 24 are cooked or baked. In the second scenario, sheet 18 is thrown away before or after goods 24 are cooked or baked.

In an eighth step 40, a plurality of baking pans 38 are placed into a commercial oven 42 and goods 24 are cooked or baked.

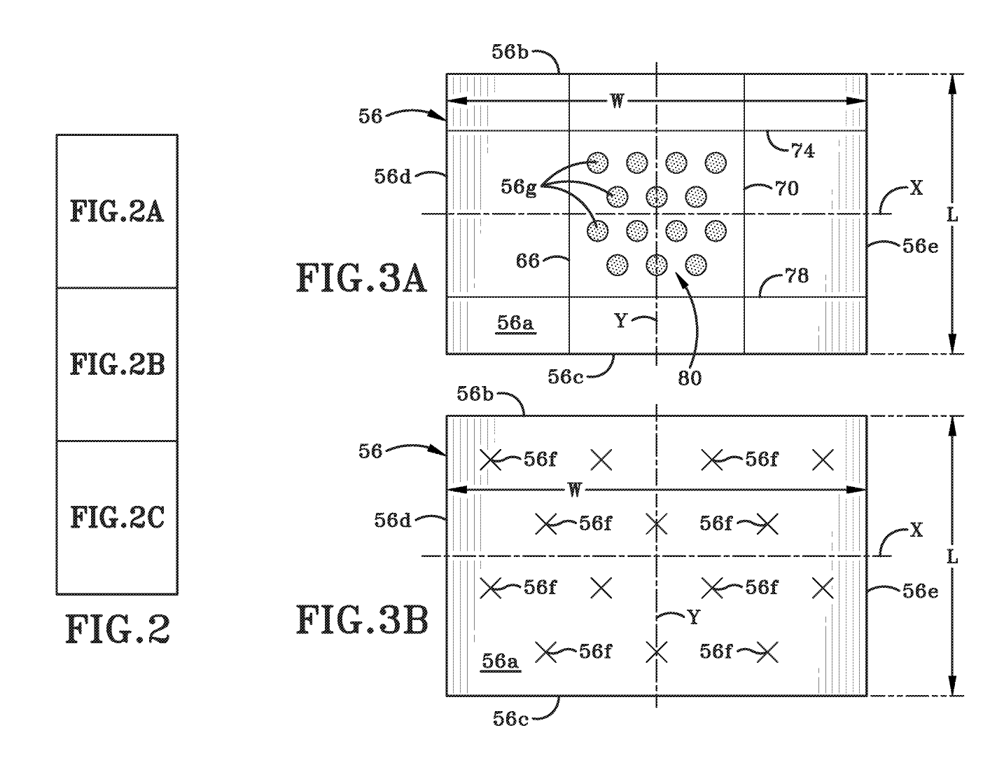

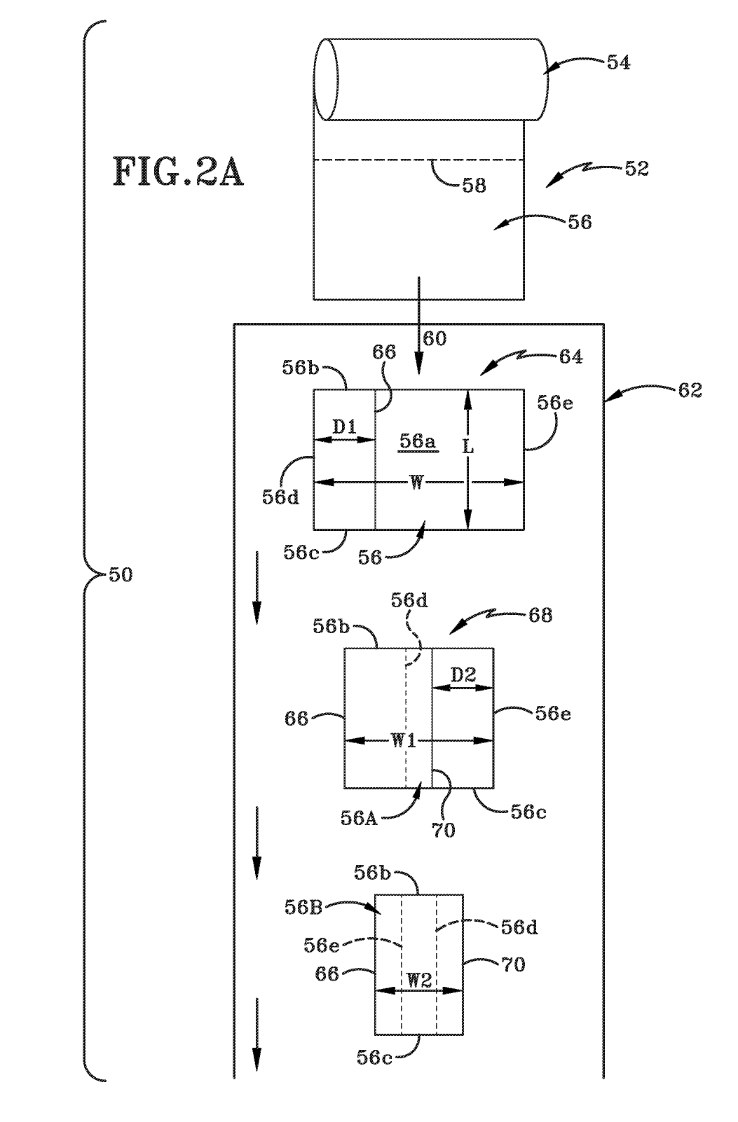

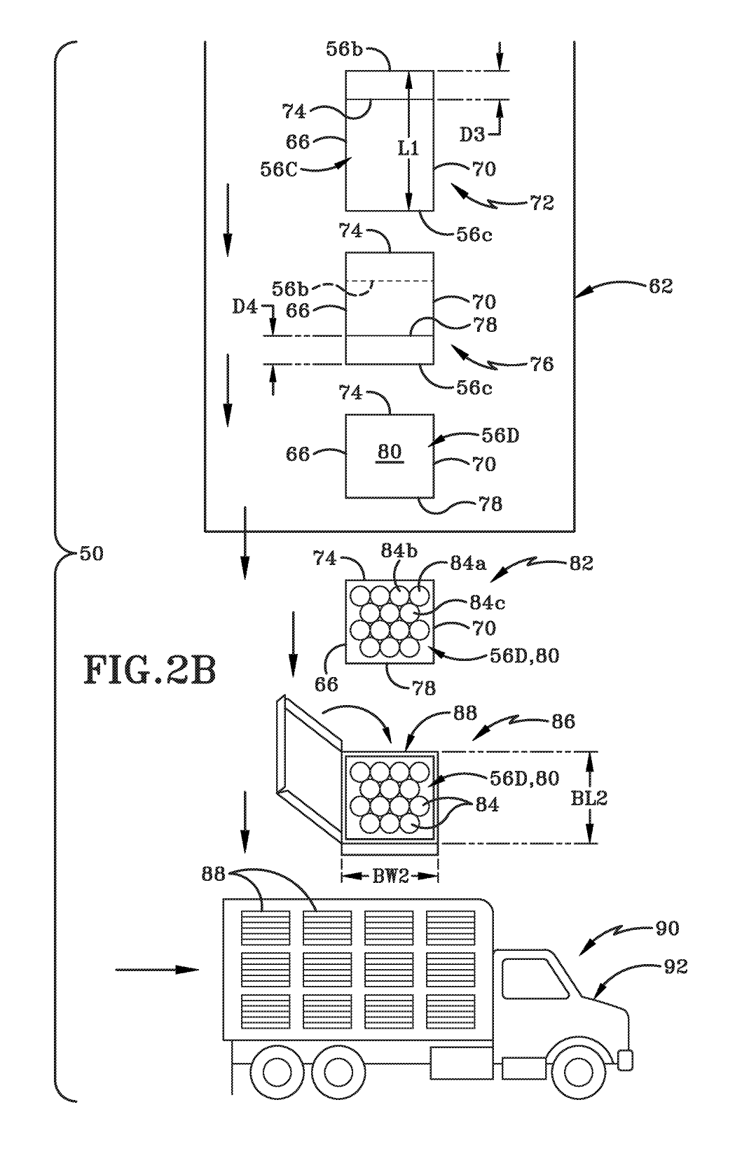

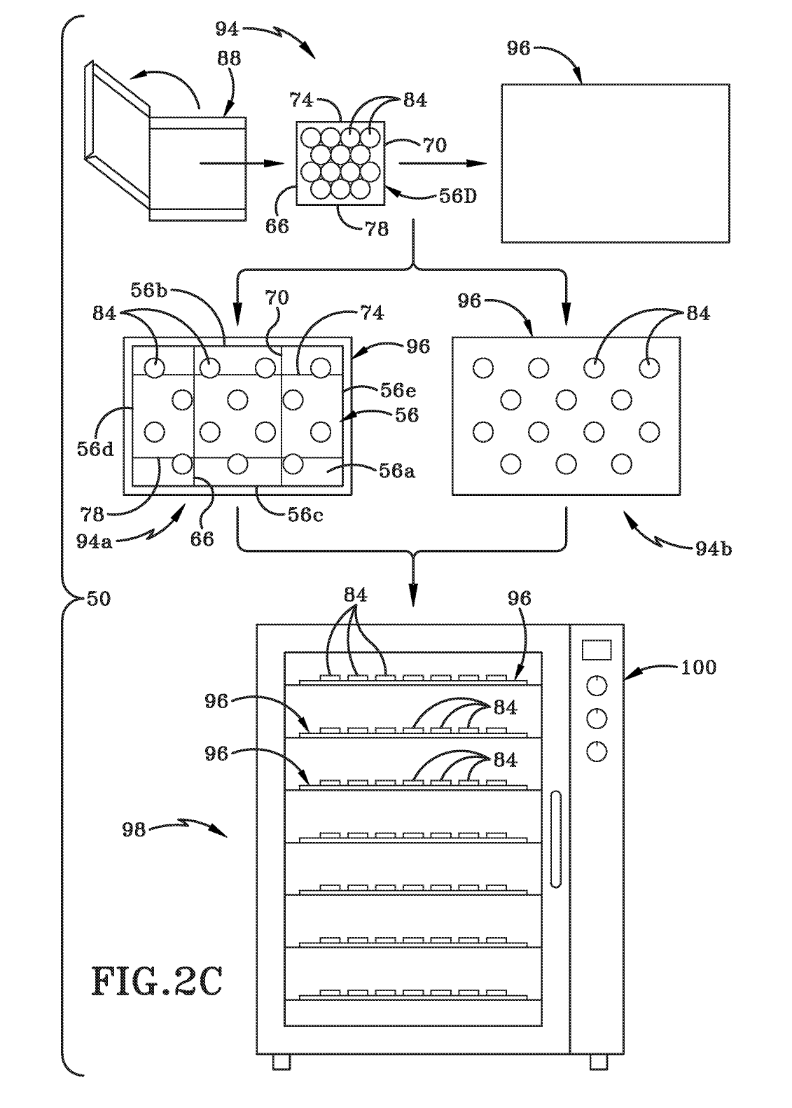

FIGS. 2 to 2C illustrate a first method of packaging and shipping, and cooking edible goods in accordance with an aspect of the present disclosure. The method is indicated by the reference number 50. In a first step 52, a twenty-four inch wide roll 54 of a baking substrate is provided. Roll 54 is passed through a cutting process where a cutting implement (not shown) is used to cut sixteen inch length individual sheets 56 of baking substrate from roll 54. A line of weakness 58 is shown on the length of baking substrate extending outwardly from roll 54 to illustrate where the cutting implement will cut sheet 56 free from roll 54. The cutting implement severs a plurality of sheets 56 from roll 54.

FIG. 3 shows sheet 56 in greater detail. Each single sheet 56 has a length “L” that is sixteen inches long and a width “W” that is twenty-four inches wide. Sheet 56 includes an upper surface 56a and an opposed lower surface that is not illustrated herein. Sheet 56 further includes a first edge 56b, a second edge 56c, a first side 56d, and a second side 56e. First and second edges 56b, 56c are opposed and first and second sides 56d, 56e are opposed. Sheet 56 has a longitudinal axis “Y” that extends between first and second edges 56b, 56c. Sheet 56 also has a lateral axis “X” that extends between first and second sides 56d, 56e. Longitudinal axis “Y” and lateral axis “X” are oriented at ninety degrees relative to each other.

Referring once again to FIGS. 2 to 2C, in a second step 60 of method 50, each single sheet 56 is passed into a folding machine 62. It should be understood that the folding machine 62 may be a separate device through which sheet 56 is passed. In other examples, devices such as dough extruding machines may be modified to perform a folding operation. Any device that may be utilized to fold sheets of baking substrate to reduce the dimensions thereof are contemplated to be a folding machine 62 in accordance with the present disclosure. Furthermore, sheet 56 may be manually folded by hand. Any manner of folding sheet 56 to reduce the dimensions thereof are contemplated to fall within the scope of the present disclosure.

Folding machine 62 in a first folding step 64 produces a first fold 66 in sheet 56. First fold 66 may be a longitudinally oriented fold, i.e., first fold 66 extends from first edge 56b to second edge 56c. First fold 66 may also be spaced a distance “D1” inwardly from first side 56d and may be oriented generally parallel to first side 56d such that a first region of sheet 56 is defined between first fold 66 and first side 56d and a second region of sheet 56 is defined in sheet 56 on an opposite side of first fold 66. In one example, first fold 66 may simply be a fold line along which sheet 56 may later be physically folded. In another example, sheet 56 is physically folded along first fold 66 so that the width of sheet 56 is reduced from the width “W” by the distance “D1”. The reduced width sheet is illustrated in FIGS. 2 to 2C by the reference number 56A and is shown as part of a second folding step 68.

In second folding step 68, folding machine 62 may produce a second fold 70 in sheet 56. Second fold 70 may also be a longitudinally-oriented fold that extends from first edge 56b to second edge 56c. Second fold 70 may be spaced a distance “D2” from second side 56e and may be oriented substantially parallel to second side 56e and a third region of sheet 56 is defined between second fold 70 and second side 56e. Second fold 70 may also be substantially parallel to first fold 66. The second region of sheet may be defined between first fold 66 and second fold 70.

In a first example, second fold 70 may simply be a fold line along which sheet 56A may later be folded. In another example, sheet 56A may be physically folded along second fold 70 so that the width of sheet 56A is reduced from the width “W1” by the distance “D2”. The reduced width sheet is illustrated in FIGS. 2 to 2C by the reference number 56B and is shown as part of a third folding step 72. In each of sheets 56A and 56B, the length of the sheet remains unchanged, i.e., the length of sheets 56A and 56B is the length “L” of sixteen inches.

It will be understood that in a first example, “D1” and “D2” may be equal in size. In a second example, “D1” and “D2” may be different in size. The specific amount of material of sheet 56 that may be folded about folds 66 and 70 relative to the rest of sheet 56 can vary considerably and any width of folded material is considered to fall within the scope of the present disclosure.

It will further be understood that first fold 66 and second fold 70 may be simultaneously formed in sheet 56. In another instance, first fold 66 may be formed first and second fold 70 may be formed after first fold 66. In yet another instance, second fold 70 may be formed first and first fold 66 may be formed second.

FIGS. 2 to 2C show that sheet 56 may go through a third folding step 72 where a third fold 74 is formed in sheet 56. The third fold 74 may extend from first side 56d to second side 56e (or from first fold 66 to second fold 70). Third fold 74 may be oriented generally parallel to transverse axis “X” and may be generally parallel to first edge 56b. Third fold 74 may be spaced a distance “D3” inwardly from first edge 56b such that a fourth region is defined between third fold 74 and first edge 56b and the second region of sheet 56 is located on an opposite side of third fold 74 from the fourth region. In a first example, third fold 74 may simply be a fold line along which sheet 56B may later be folded. In another example, sheet 56B may be physically folded along third fold 74 so that the length of sheet 56B is reduced from the length “L” by the distance “D3”. The reduced length is indicated by the reference number “L1” and the further-folded sheet is represented by reference number 56C.

FIGS. 2 to 2C show that sheet 56C may go through a fourth folding step 76 where a fourth fold 78 is formed in sheet 56. The fourth fold 78 may extend from first side 56d to second side 56e (or from first fold 66 to second fold 70). Fourth fold 78 may be generally parallel to transverse axis “X” and may be generally parallel to second edge 56c. Additionally, fourth fold 78 may be generally parallel to third fold 74 such that a fifth region is defined between fourth fold 78 and second edge 56c. The second region of sheet 56 is located on an opposite side of fourth fold 78 from the fifth region. Fourth fold 78 may be located a distance “D4” inwardly from second edge 56c. In a first example, fourth fold 78 may be a fold line along which sheet 56C may later be folded. In another example, sheet 56C may be physically folded along fourth fold 78 so that the length of sheet 56B is reduced from the length “L1” by the distance “D4” to result in a length “L2”.

The second region of sheet 56 is thus bounded and defined by first fold 66, second fold 70, third fold 74, and fourth fold 78. The second region of sheet 56 comprises an area upon which goods may be placed, as will be described later herein. In a first example, when sheet 56 is folded, the folding about each of the first fold 66, second fold 70, third fold 74, and fourth fold 78 is all in the same direction. In other examples, folding of the sheet 56 about one or more of the folds may occur in different directions to folding about other of the folds.

It will be understood that third fold 74 and fourth fold 78 may be simultaneously formed in sheet 56. In another instance, third fold 74 may be formed first and fourth fold 78 may be formed after third fold 74. In yet another instance, fourth fold 78 may be formed first and third fold 74 may be formed after fourth fold 78.

In a first example, “D3” and “D4” may be equal in size. In a second example, “D3” and “D4” may be different in size. The specific amount of material of sheet 56 that may be folded about folds 74 and 78 relative to the rest of sheet 56 can vary considerably and any width of folded material is considered to fall within the scope of the present disclosure.

It will be understood that less than all four folds 66, 70, 74, and 78 may be made in sheet 56. Making only one fold will reduce the surface area upon which goods may be placed. Making two folds will reduce that surface area even more. Making three folds will reduce the surface area even further, and making all four folds will still further reduce the surface area. It will be understood that the order of making the folds may be changed from what has been described above. It will further be understood that additional folds other than those described herein may also be made to the sheet. So, for example, a fifth fold, a sixth fold or other additional folds may be formed in sheet 56.

After all four folds 66, 70, 74, and 78 have been made, the resultant sheet is indicated by the reference number 56D. Sheet 56D has a length “L2” and a width “W2”, where the length “L2” is smaller than the original length “L” and the width “W2” is smaller than the original width “W”. The sheet 56D presents a goods-receiving area 80 on its upper surface.

In a third step 82 of method 50, a plurality of goods 84 are placed on goods-receiving area 80 of sheet 56D. Since the goods-receiving area 80 is smaller than the upper surface 56a of sheet 56 in an unfolded state, goods 84 are more tightly spaced than was the case in PRIOR ART method 10. In particular, adjacent goods 84 may contact each other. In other words, there is little open space surrounding each individual good 84. So, for example, good 84a contacts good 84b, and also contacts good 84c, amongst others. During production of edible goods 84, such as cookies, a dough machine may drop pucks of dough on sheet 56 and the dough is then quickly flash frozen on sheet 56. The sheet 56 of baking substrate will interleave and transit the dough.

It will be understood that the various regions of sheet 56 that are located between the fold lines 66, 70, 74, and 78 and the associated edge or side 56c, 56d, 56b, and 56c may be folded under the bottom surface of sheet 56 or may be folded over upper surface 56a. If the latter occurs, then the regions of sheet 56 may be placed over a top surface of at least some of goods 84.

It will be understood that sheet 56 may be folded along only one of fold lines 66, 68, 74, 78 or along more than one of the fold lines 66, 68, 74, 78 or all of the fold lines 66, 68, 74, 78. The particular, the reduction in sheet size may be selected by the company responsible for packaging goods 84. The selected size may be determined based on the number of goods 84 that are to be carried on sheet 56.

In a fourth step 86, a box 88 may be selected to carry the reduced-dimension sheet, i.e., 56A, 56B, 56C, or 56D depending on how many of the folds 66, 70, 74, and 78 have been folded to reduce the sheet size. The specific size of box 88 may be selected based on the selected folded size of sheet 56A, 56B, 56C, or 56D. Box 88 is selected such that it is marginally larger than sheet 56A, 56B, 56C, or 56D when the sheet has at least one or more of folds 66, 68, 74, 78 formed therein. In other words, box 88 is selected so that it is has dimensions that are smaller than the sheet 56 prior to folding along one or more of fold lines 66, 68, 74, 78. In the fourth step 86, after selection of box 88, sheet 56D, for example, with goods 84 thereon is placed in the interior cavity of box 88. Because of the reduced length “L2” and width “W2” of sheet 56D, the size of box 88 may be only marginally larger than length “L2” and width “W2”. Box 88 may have a length “BL2” that is smaller than the length “L” of the unfolded sheet 56 but is marginally larger than the length of sheet 56 when folded. Box 88 may have a width “BW2 that is smaller than the width “W” of the unfolded sheet 56 but is marginally larger than the width of sheet 56 when folded. The packaging costs for shipping goods 84 are therefore reduced because each individual sheet 56D of goods 84 does not need to be shipped in a box that is larger than twenty-four inches wide and sixteen inches long. Sheet 56D with goods 84 thereon may be placed within the interior cavity of box 88. In another example, box 88 may be assembled around an exterior perimeter of sheet 56D either before or after goods 84 have been placed on the upper surface 56a of the sheet.

In a fifth step 90, a plurality of boxes 88 may be transported by vehicle 92 to a commercial operation where the goods 84 will later be cooked or baked. Because boxes 88 are smaller than the required PRIOR ART boxes 32, more boxes 88 may be loaded onto or into vehicle 92. Consequently, the cost per box shipped is reduced relative to the PRIOR ART shipping costs.

In a sixth step 94, goods 84 are placed on a baking pan 96 for cooking or baking. Goods 84 from a single sheet 56D that has been packaged and transported in one of the plurality of boxes 88 may be placed onto a separate baking pan 96. In a first example 94a, sheet 56D is unfolded so that sheet reassumes its original width “W” and length “L” of twenty-four inches by sixteen inches. The unfolded sheet 56 is then placed on baking pan 96 and the individual goods 84 are moved away from each other so that each good 84 has space separating it from adjacent goods 84. In a second example 94b, goods 84 are removed from sheet 56D and are placed directly upon the upper surface of baking pan 96. Goods 84 are separated from each other so that a space surrounds each good 84, giving the good the opportunity to expand during cooking and thereby reducing the chances of the goods 84 becoming connected to each other during cooking. The sheet 56D is thrown away.

In a seventh step 98 a plurality of baking pans 96 with goods 84 thereon (either on top of sheet 56 or directly on pan 96) are placed into a commercial oven 100 and are cooked. Sheet 56 of baking substrate may therefore serve two purposes. Firstly, it may be used to interleave batches of uncooked edible goods 84 (i.e., separate them from each other). Secondly, sheet 56 of baking substrate may serve as a pan liner during a baking or cooking process of the edible goods 84.

If the step 94a is utilized in the sixth step, then the unfolded sheet 56 is thrown away once the goods 84 are cooked or baked.

It is important to note in the first method 50 in accordance with the present disclosure, that sheets 56 are not cut by a cutting implement in order to reduce their length “L” and/or their width “W”. Instead, sheets 56 are temporarily folded to reduce their length “L” to a length “L1” and/or their width “W” to a width “W1”. The first method 50 therefore permits the use of the industry standard twenty-four inch by sixteen inch sheets of baking substrate. The sheets of baking substrate are simply temporarily reduced in length and/or width during packaging and transportation of the goods 84 but are then unfolded and returned to the industry standard size for baking of the edible goods 84 carried thereon.

The reduced dimension sheets 56A, 56B, 56C, 56D permit the use of smaller boxes 88 than is possible with PRIOR ART methods such as the one illustrated in FIG. 1. The use of smaller boxes 88 reduces costs for packaging and/or transportation of the goods 84. Conversely, the number of boxes 88 that may be placed into a shipping container may be increased because of the smaller size boxes 88 that are able to be used to ship the same number of goods 84 as using the PRIOR ART method 10. The increase in the number of boxes 88 that may be placed in a shipping container will reduce the average cost per item shipped.

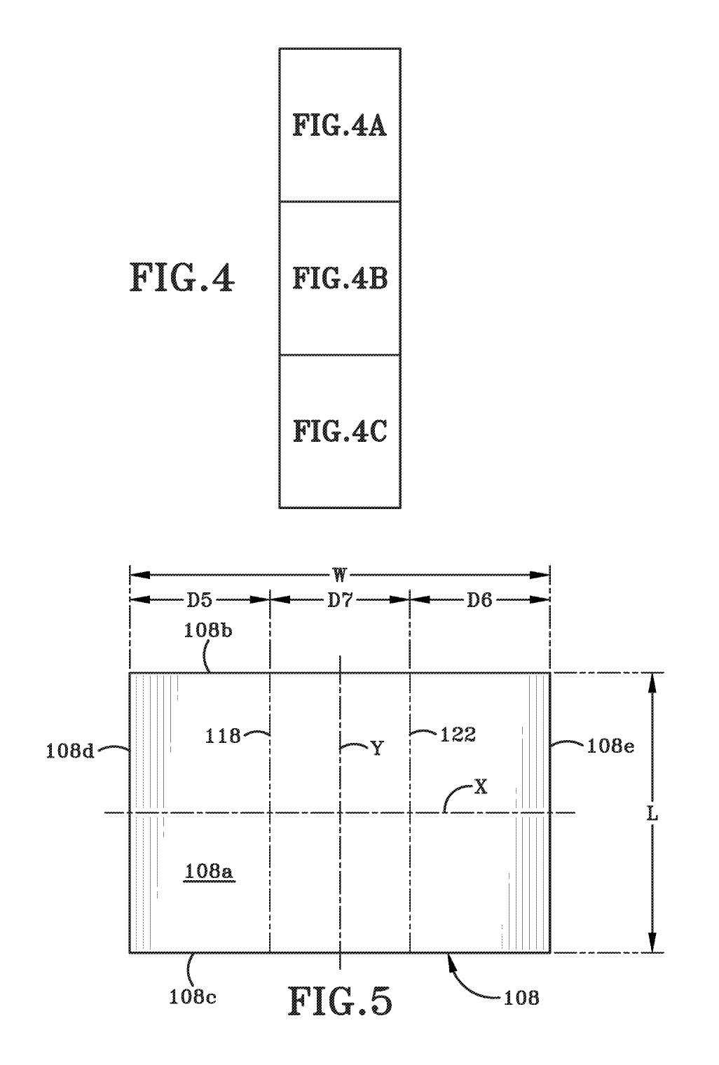

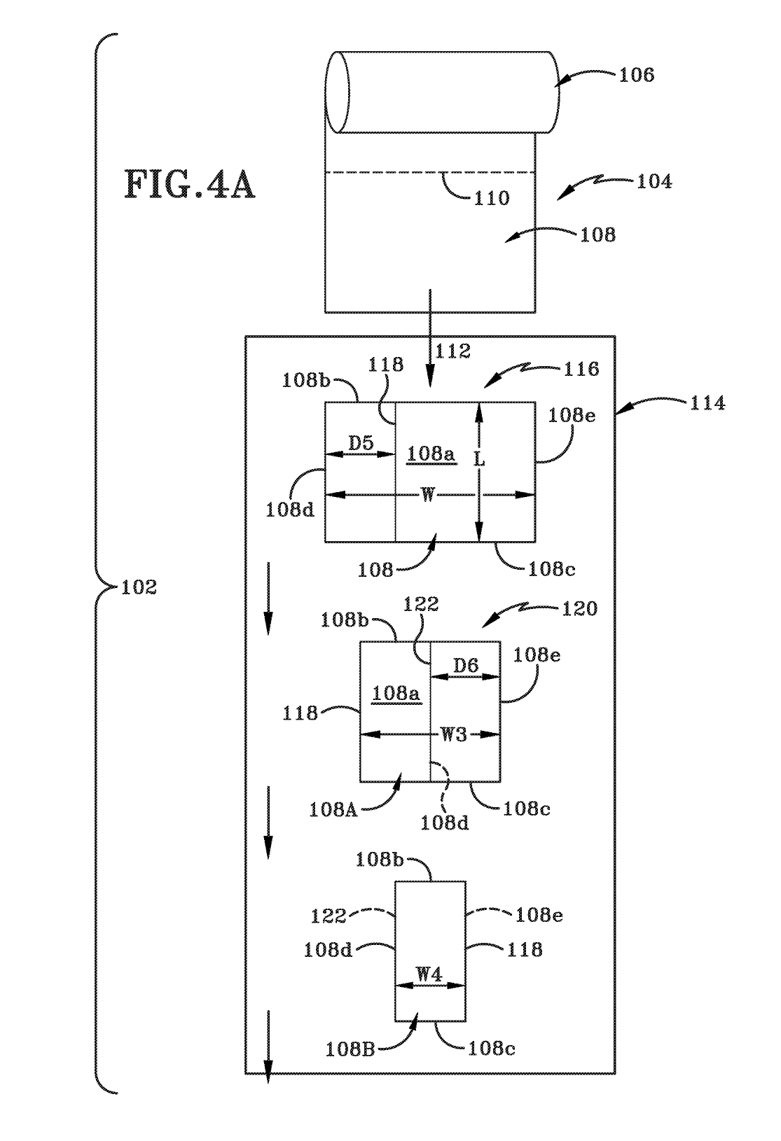

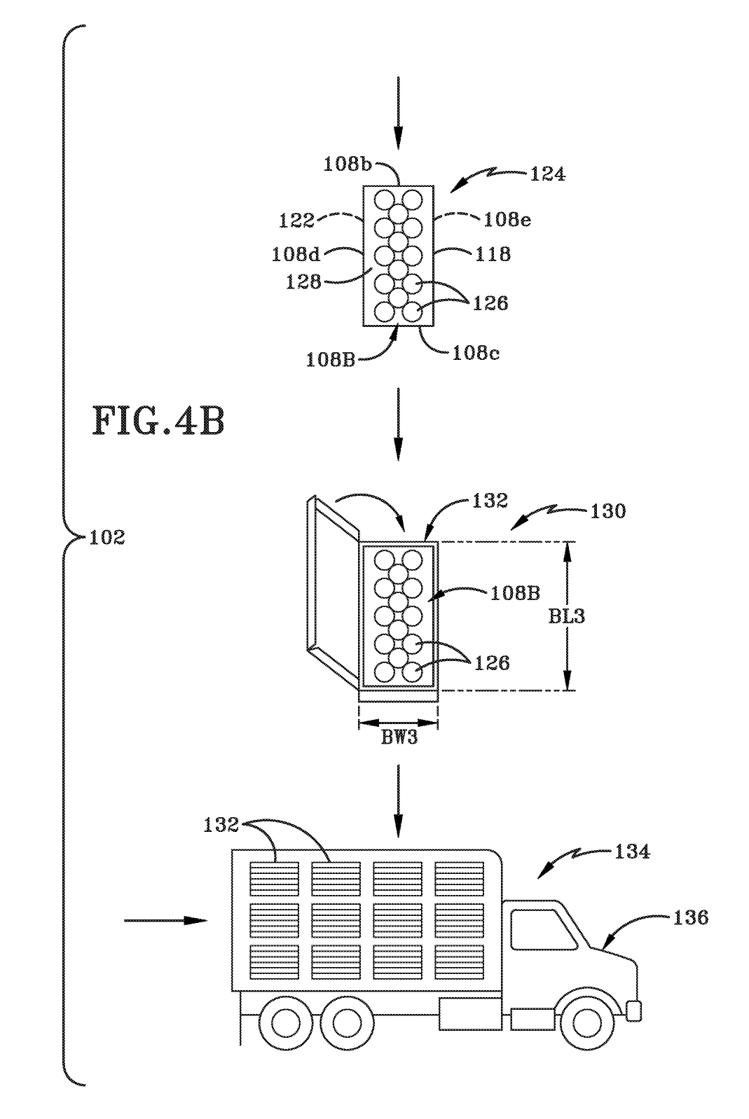

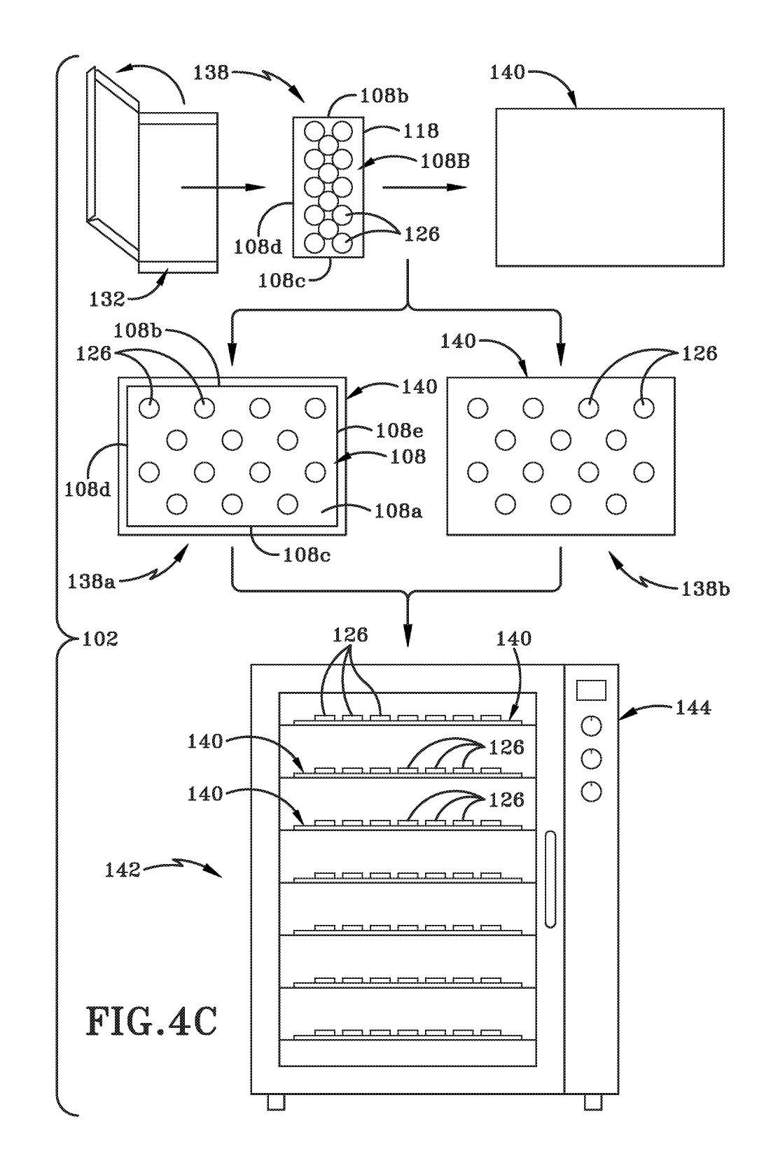

FIGS. 4 to 4C show a second embodiment of a method of packaging and shipping, and cooking edible goods in accordance with an aspect of the present disclosure. The method is indicated by the reference number 102. In a first step 104, a twenty-four inch wide roll 106 of a baking substrate is provided. Roll 106 is passed through a cutting process where a cutting implement (not shown) is used to cut sixteen inch length individual sheets 108 of baking substrate from roll 106. A line of weakness 110 is shown on the length of baking substrate extending outwardly from roll 106 to illustrate where the cutting implement will cut sheet 108 free from roll 106. The cutting implement severs a plurality of sheets 108 from roll 106.

FIG. 5 shows sheet 108 in greater detail. Each single sheet 108 has a length “L” that is sixteen inches long and a width “W” that is twenty-four inches wide. Sheet 108 includes an upper surface 108a and an opposed lower surface that is not illustrated herein. Sheet 108 further includes a first edge 108b, a second edge 108c, a first side 108d, and a second side 108e. First and second edges 108b, 108c are opposed and first and second sides 108d, 108e are opposed. Sheet 108 has a longitudinal axis “Y” that extends between first and second edges 108b, 108c. Sheet 108 also has a lateral axis “X” that extends between first and second sides 108d, 108e. Longitudinal axis “Y” and lateral axis “X” are oriented at ninety degrees relative to each other. Sheet 108 is therefore substantially identical to sheet 56.

Referring once again to FIGS. 4 to 4C, in a second step 112 of method 102, each single sheet 108 is passed into a folding machine 114. Folding machine 114 in a first folding step 116 produces a first fold 118 in sheet 108. First fold 118 may be a longitudinally oriented fold, i.e., first fold 118 extends from first edge 108b to second edge 108c. First fold 118 may also be spaced a distance “D5” inwardly from first side 108d and may be oriented generally parallel to first side 108d. In one example, first fold 118 may simply be a fold line along which sheet 108 may later be physically folded. In another example, sheet 108 is physically folded along first fold 118 so that the width of sheet 108 is reduced from the width “W” by the distance “D5” to a width “W3”. The reduced width sheet is illustrated in FIGS. 4 to 4C by the reference number 108A. Sheet 108A is of the same length “L” as the unfolded sheet 108.

In second folding step 120, folding machine 114 may produce a second fold 122 in sheet 108. Second fold 122 may also be a longitudinally-oriented fold that extends from first edge 108b to second edge 108c. Second fold 122 may be spaced a distance “D6” from second side 108e and may be oriented substantially parallel to second side 108e. Second fold 122 may also be substantially parallel to first fold 118 and to second side 108e. Second fold 122 may be spaced a distance “D7” from first fold 118.

In a first example, second fold 122 may simply be a fold line along which sheet 108A may later be folded. In another example, sheet 108A may be physically folded along second fold 122 so that the width of sheet 108A is reduced from the width “W3” by the distance “D6” to a width “W4”. The resultant sheet 108B has an unchanged length “L” relative to the unfolded sheet 108 but has a much reduced width of “W4”. In one example, distances “D5”, “D6”, and “D7” are all of the same size. In particular, “D5”, “D6”, and “D7” may all be eight inches wide in which case sheet 108B has a width “W4” that is eight inches wide. The length “L” remains at sixteen inches long.

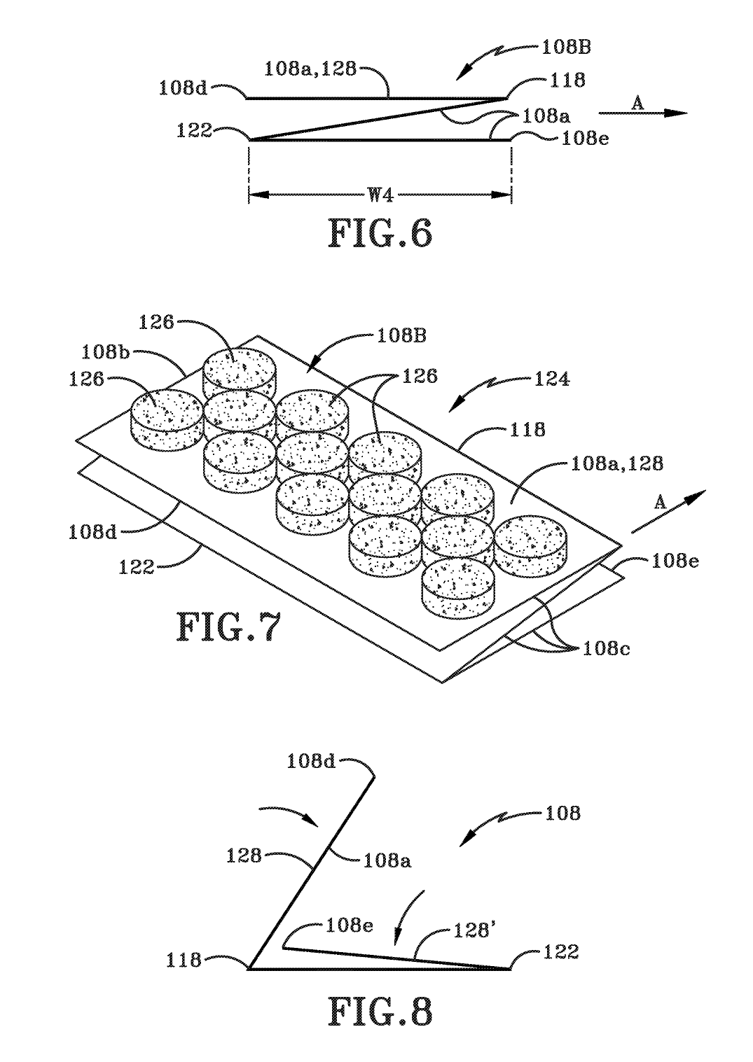

FIG. 6 show one exemplary manner in which sheet 108 may be folded in accordance with the present disclosure. In particular, the sheet 108 may be folded in a first direction about first fold 118 and may be folded in the opposite direction about second fold 122. When the folded sheet 108 is viewed from either end as in FIG. 6, the twice-folded sheet 108 may have a “Z-shape”.

In a third step 124 shown in FIGS. 4 and 7, a plurality of goods 126 are placed on a goods-receiving area 128 (FIG. 7) of sheet 108B. The goods-receiving area 128 is defined between first side 108d and first fold 118. Because of the reduced dimensions of sheet 108B, goods 126 are placed in contact with each other.

In a fourth step 130, a box 132 is selected for packaging sheet 108B and goods 126 thereon. Box 132 is selected based on the reduced dimensions of sheet 108B. Box 132 may have a length “BL3” that is smaller than the length “L” of the unfolded sheet 108 but is marginally larger than the length of sheet 108 when folded. Box 132 may have a width “BW3 that is smaller than the width “W” of the unfolded sheet 108 but is marginally larger than the width of sheet 108 when folded. Sheet 108B with goods 126 thereon is received within the interior cavity of box 132.

In a fifth step 134, a plurality of boxes 132 are loaded on a vehicle 136 and are transported to a retailer.

In a sixth step 138, goods 126 are placed onto a baking sheet 140. In a first instance 138a, sheet 108B is unfolded to form an unfolded sheet 108 and the goods 126 are spread apart from each other on upper surface 108a of the unfolded sheet 108. Folded sheet 108B may be relatively easily unfolded. In a first unfolding step the user will place the folded sheet 108B on a flat surface and while holding the first edge 108d stationary on the flat surface, the user will pull the second edge 108e in the direction indicated by arrow “A” in FIGS. 6 and 7. This motion will leave all of the goods 126 initially on the good-receiving surface 128 between first side 108d and first fold 118. The user will then move some of the goods 126 into the areas between first fold 118 and second fold 122 and between second fold 122 and second side 108e.

The Z-shape of the folded sheet permits easy unfolding because the first side 108d and the second side 108e of the unfolded sheet 108 remain as the outermost edges of the sheet 108 when folded. One or both of the first and second sides 108d, 108e may therefore act as a “handle” that the user can readily grasp and pull outwardly on in order to unfold the folded sheet. A baker may therefore place the folded sheet 108 with goods 126 thereon into baking pan 140 and can simply hold down the first side 108d of sheet against a left side of the pan 140 and in one simple motion can pull the second side 108e of sheet 108 toward the right side of the pan 140 to form a full-size standard twenty-four inch by sixteen inch baking pan liner. This also has the advantage of lessening the total disturbance on the goods 126.

In an alternative example, indicated by 138b in FIGS. 4 to 4C, goods 126 may be removed from folded sheet 108B and be placed directly onto the upper surface of baking pan 140.

In a seventh step 142 of method 102, a plurality of baking pans 140 with goods 126 thereon are placed in a commercial oven 144 and the goods 126 thereon are cooked or baked by oven 144. Sheet 108 is discarded after cooking or baking of goods 126 if the first instance 138a of placing goods 126 on baking pan 140 is selected. If the second instance 138b of placing goods 126 on baking pan 140 is selected then sheet 108 is discarded once goods 126 have been moved onto baking pan 140.

It will be understood that sheet 108 may be folded in a manner other than in a Z-shape by simply folding sheet 108 in the same direction about first fold 118 and second fold 120. This other manner of folding is illustrated in FIG. 8. In this instance, the goods 126 will again be placed on a goods-receiving area 128 defined between first side 108d and first fold 118. It will be understood that in another example, the region between second side 108e and second fold 122 may be positioned to overlap the goods-receiving area 128. In this latter example, the goods will be placed on a region of the lower surface of sheet 108 that is located between second end 108e and second fold 122. This region of the lower surface is indicated by the reference number 128′.

It will further be understood that instead of making two longitudinally-oriented folds 118, 122 in sheet 108, folding machine 114 may be configured to make two spaced-apart laterally oriented folds in sheet 108.

It will further be understood that instead of two longitudinally-oriented folds 118, 122 (or two transversely-oriented folds) being made by folding machine 114, less than two parallel folds may be made in sheet 108 or more than two parallel folds may be made in sheet 108.

It should be noted that in either of the first method 50 or the second method 102, that the goods-receiving surface of sheet 56 or sheet 108 may be marked in some manner to either show where each of the edible goods should be placed in order to ensure those goods are less likely to be damaged when boxed and shipped. In other instances, the markings may show where to place edible goods after the sheet has been unfolded onto a baking pan. In this instance, the markings are provided to ensure placement of the edible goods, such as cookies, so that the individual cookies will be moved sufficiently far enough away from each other so as to not merge together into a single giant cookie during baking. FIG. 3A, for example, shows one or more markings 56f provided on upper surface 56a of sheet 56. The markings 56f indicate where individual edible goods should be moved to once sheet 56 is unfolded after shipping and prior to cooking or baking of the edible goods.

In other examples, some type of food-grade adhesive may be applied to either the edible good or to the goods-receiving surface in order to hold the individual edible goods in place on sheet 56 or 108. (A food-grade adhesive is one that is edible or suitable for human consumption.) FIG. 3B, for example, shows one or more detents 56g of food grade adhesive provided on the goods-receiving surface of sheet 56. The detents 56g are only provided on the surface of sheet 56 upon which edible goods will be placed prior to shipping. The adhesive will hold the edible goods in place so that they do not move around on the sheet while placed within the box and thereby become damaged.

It will be understood that while the methods described above have been disclosed as involving a sheet of baking substrate being cut from a roll of baking substrate, in instances where a film is utilized as the baking substrate, sheets of the film may be extruded and then folded as part of the packaging process instead of those film sheets being cut from a roll of film.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the disclosure are an example and the disclosure is not limited to the exact details shown or described.

What is claimed:

1. A method of packaging, shipping and cooking an uncooked edible good comprising steps of:
providing a sheet that is of a first length and of a first width;
folding a first region of the sheet relative to a second region of the sheet about a first fold;
reducing one or both of the first length to a second length and the first width to a second width through the folding to produce a reduced dimension sheet;
placing one or more edible goods on the reduced dimension sheet;
placing the reduced dimension sheet with the one or more edible goods thereon into an interior cavity of a box; and
transporting the box from a first location to a second location.

2. The method according to claim 1, further comprising:
selecting the box for transporting the one or more edible goods, where the box has one or both of the second length and the second width.

3. The method according to claim 1, wherein the step of reducing does not include one or both of cutting the sheet to reduce the first length to the second length and cutting the sheet to reduce the first width to the second width.

4. The method according to claim 1, further comprising:
removing the reduced dimension sheet with the one or more edible goods thereon from the box at the second location.

5. The method according to claim 4, further comprising:
unfolding the reduced dimension sheet to form an unfolded sheet; and
increasing one or both of the second length to the first length and the second width to the first width by the unfolding.

6. The method according to claim 5, further comprising:
placing the unfolded sheet onto a baking pan;
placing the baking pan into an oven; and
cooking the one or more edible goods with the oven.

7. The method according to claim 1, further comprising:
removing the one or more edible goods from the reduced dimension sheet at the second location;
placing the one or more edible goods onto a baking pan;
placing the baking pan into an oven; and
cooking the one or more edible goods with the oven.

8. The method according to claim 1, wherein the folding comprises:
forming the first fold in the sheet such that the first fold extends from a first edge to a second edge of the sheet; and
spacing the first fold a first distance from a first side of the sheet.

9. The method according to claim 8, wherein the folding further comprises:
forming a second fold in the sheet; where the second fold extends from the first edge to the second edge of the sheet; wherein the second fold is spaced laterally from the first fold and is parallel thereto; and
spacing the second fold a second distance from a second side of the sheet.

10. The method according to claim 8, wherein the folding further comprises:
forming an additional fold in the sheet, wherein the additional fold is oriented at right angles to the first fold.

11. The method according to claim 9, wherein the folding further comprises:
forming a third fold and a fourth fold in the sheet, wherein the third fold and the fourth fold are oriented at right angles to the first fold and the second fold; and wherein the fourth fold is spaced longitudinally from the third fold.

12. The method according to claim 9, wherein the folding further comprises:
defining a first region of the sheet between a first side and the first fold;
defining a second region of the sheet between the first fold and the second fold;
defining a third region of the sheet between the second fold and a second side;
folding the first region relative to the second region about the first fold in a first direction; and
folding the second region relative to the third region about the second fold in a second direction; wherein the reduced dimension sheet has a Z-shape when viewed from an end that is oriented at right angles to the first side.

13. The method according to claim 12, further comprising:
spacing the first fold a first distance from the first side;
spacing the second fold a second distance from the second side; and
spacing the first fold a third distance from the second fold.

14. The method according to claim 13, wherein the spacing of the first fold and the second fold includes selecting the first distance, the second distance and the third distance to be of equal size.

15. The method according to claim 12, further comprising:
unfolding the Z-shape of the sheet by holding the first side of the sheet stationary and moving the second side of the sheet laterally away from the first side in a direction perpendicular to the first side.

16. A packaging system for one or more edible goods comprising:
a sheet of a baking substrate that is of a first length and a first width;
a goods-receiving surface provided on the sheet; wherein the goods-receiving surface is adapted to receive one or more edible goods thereon;
a box having an interior cavity for receiving the sheet therein; wherein the box has one or both of a second length and a second width, wherein the second length is smaller than the first length and the second width is smaller than the first width; and wherein the sheet of paper is folded in order to be received into the interior cavity of the box.

17. The packaging system according to claim 16, wherein the sheet includes a first fold line about which a first region of the sheet is folded relative to a second region of the sheet to change one or both of the first length to the second length and the first width to the second width.

18. The packaging system according to claim 17, wherein the sheet includes a second fold line about which a third region of the sheet is folded relative to the second region of the sheet to change one or both of the first length to the second length and the first width to the second width.

19. The packaging system according to claim 18, wherein the first fold line and the second fold line are parallel to each other.

20. The packaging system according to claim 18, wherein the first fold line and the second fold line are oriented at right angles to each other.

21. The packaging system according to claim 19, wherein the sheet is folded in a first direction around the first fold line and is folded in a second direction around the second fold line; wherein the sheet has a Z-shape when viewed from an end of the sheet that is oriented at right angles to the first fold line.

22. The packaging system according to claim 19, wherein the sheet further comprises:
a third fold line oriented at right angles to the first fold line; and wherein a fourth region of the sheet is folded about the third fold line relative to the second region of the sheet to change one or both of the first length to the second length and the first width to the second width.

23. The packaging system according to claim 22, wherein the sheet further comprises:
a fourth fold line spaced longitudinally from the third fold line and oriented parallel to the third fold line; and wherein a fifth region of the sheet is folded about the fourth fold line relative to the second region of the sheet to change one or both of the first length to the second length and the first width to the second width.

24. A packaging system for one or more edible goods comprising:
a sheet of a baking substrate that is of a first length and a first width;
at least one fold line provided on the sheet; wherein a first region of the sheet is foldable relative to a second region of the sheet about the at least one fold line to reduce one or both of the first length to a second length and the first width to a second width;
a goods-receiving surface provided on the sheet; and
one or more edible goods positioned on the goods-receiving surface.

25. The packaging system according of claim 24, further comprising one or more markings provided on the goods-receiving surface, wherein each of the one or more markings indicates where to position each of the one or more edible goods.

26. The packaging system according to claim 24, further comprising one or more detents of food-grade adhesive provided on the goods-receiving surface, wherein each of the one or more detents of food-grade adhesive secures one of the one or more edible goods to the goods-receiving surface.
